(19) United States
(12) Patent Application Publication
(10) Pub. No.: US 2016/0112517 A1
(43) Pub. Date: Apr. 21, 2016

(54) VEHICLE PERFORMANCE CUSTOMIZATION VIA DOWNLOADABLE APPLICATIONS

(71) Applicant: ROBERT BOSCH GMBH, Stuttgart (DE)

(72) Inventor: Andrew Wilson, Farmington Hills, MI (US)

(73) Assignee: Robert Bosch GmbH, Stuttgart (DE)

(21) Appl. No.: 14/891,273

(22) PCT Filed: May 13, 2014
(86) PCT No.: PCT/US2014/037770

§ 371 Date: Nov. 13, 2015

Related U.S. Application Data
(60) Provisional application No. 61/823,699, filed on May 15, 2013.

(51) Int. Cl. H04L 29/08; G06F 9/445

(52) U.S. Cl. CPC H04L 67/12; H04L 67/34; H04L 67/10; G06F 8/61

(57) ABSTRACT

Methods, systems, and computer-readable medium for modifying vehicle operation. One system includes a controller installed in a vehicle. The controller is configured to receive a user-selected operating parameter obtained through a downloaded application, generate a message for at least one embedded vehicle controller based on the user-selected parameter, and transmit the message to the at least one embedded vehicle controller. The message causes the embedded vehicle controller to modify operation.

### RELATED APPLICATIONS

This application claims priority to U.S. Provisional Patent Application No. 61/823,699, filed May 15, 2013, the entire content of which is hereby incorporated by reference.

### BACKGROUND

The present invention relates to methods and systems of providing software to a vehicle.

Modern vehicles include numerous computer and control systems and a vehicle network over which data from vehicle sensors and information from the computer and control systems is transmitted. For example, modern internal combustion engines often include a controller that includes software used to control fuel injection, ignition timing, and other aspects of engine operation. Other vehicle systems include anti-lock braking, adaptive cruise control, lane departure, parking assist, vehicle stability control, traction control, and others. The operation of these systems may be varied by changing the software in them. For example, engine control software may be “tuned” or configured by a vehicle manufacturer to maximize fuel economy. However, a consumer may wish to modify the performance of the vehicle to increase engine torque, horsepower, or both. However, to modify the software and, therefore, the performance of the computer system, special equipment and expertise is required. For example, often times it is necessary to use a specialized programming tool that connects to an external port of the vehicle (e.g., an on-board diagnostics II (“OBD-II”) port) to install software.

### SUMMARY

The automotive industry is increasingly focused on user connectivity, human-machine interface (“HMI”) functionality, and interactive experience in the vehicle. For example, certain manufacturers of passenger vehicles have recently announced software development environments for third-party application development.

Using, a properly developed application for the vehicle environment and a vehicle HMI it is possible to interact with embedded vehicle systems, such as the systems described above, to allows users to create an individualized vehicle experience. Accordingly, embodiments of the invention provide a system that includes a controller installed in a vehicle. The controller is configured to receive a user-selected operating parameter obtained through a downloaded application, generate a message for at least one embedded vehicle controller based on the user-selected parameter, and transmit the message to the at least one embedded vehicle controller. The message causes the embedded vehicle controller to modify operation.

Another embodiment of the invention provides a method of modifying vehicle operation. The method includes receiving, from a user, a selection of an application available for download, downloading the selected application to a device, and modifying operation of at least one embedded vehicle controller based on the selected application.

Yet another embodiment of the invention provides a non-transitory computer-readable medium including executable instructions for accessing a listing of applications available for download from a server over a wireless connection, displaying the listing of applications available for download on a user interface mounted in an interior of a vehicle, receiving, through the user interface, a selection of an application included in the listing of applications available for download, and downloading the selected application from the server over the wireless connection. The medium also including executable instructions for executing the downloaded application to generate a screen prompting a user for an operating parameter, displaying the screen on the user interface, receiving, through the user interface, the operating parameter, generating a message based on the operating parameter, and transmitting the message to at least one embedded vehicle controller over a controller area network. The message instructs the at least one embedded vehicle controller to modify software executed by the at least one embedded vehicle controller.

Other aspects of the invention will become apparent by consideration of the detailed description and accompanying drawings.

### BRIEF DESCRIPTION OF THE. DRAWINGS

FIG. 1 schematically illustrates a vehicle.

FIG. 2 schematically illustrates an application controller included in the vehicle of FIG. 1.

FIG. 3 is a flowchart illustrating a method managed by the application controller 30 of FIG. 2 to download software to the vehicle of FIG. 1.

FIG. 4 illustrates a screen generated by a downloaded application executed by the application controller of FIG. 2.

FIG. 5 illustrates a screen generated by a downloaded application executed by a mobile computing device configured to communicate with the application controller of FIG. 2.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be utilized to implement the invention. It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification can include standard processing components, such as one or more processors, one or more memory modules including non-transitory computer-readable medium, one or more input/output interfaces, and various connections (e.g., a system bus) connecting the components.

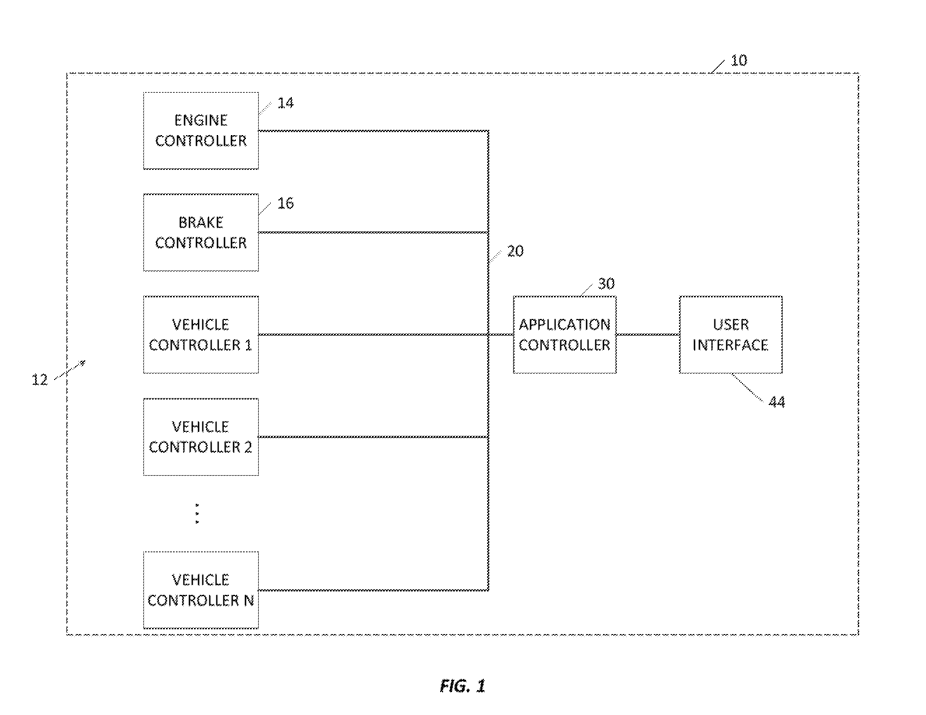

FIG. 1 schematically illustrates a vehicle 10. The vehicle 10 includes one or more embedded vehicle systems or controllers 12. Each vehicle controller 12 can include a processing unit (e.g., a microprocessor, an application-specific integrated circuit (“ASIC”), etc.), a memory module (e.g., non-transitory computer-readable medium), and an input/output interface that allows the vehicle controller 12 to communicate with other devices. The memory module associated with a vehicle controller 12 stores software executed by the processing unit to perform vehicle operation. In some embodiments, each vehicle controller 12 performs a dedicated vehicle operation. For example, as illustrated in FIG. 12, the vehicle controllers 12 can include an engine controller 14 and a brake controller 16. The engine controller 14 can execute software to control fuel injection, ignition timing, and other aspects of engine operation. Similarly, the brake controller 16 can execute software to control brake timing, anti-lock braking, traction control, and other aspects of brake operation. Other vehicle controllers 12 can control other forms of vehicle operation, such as cruise control, parking assistance, lane departure, stability control, traction control, interior control (e.g., heating and cooling, infotainment functionality, dashboard and user interface functionality, component positioning functionality for seats, mirrors, steering wheel, etc.), etc. In particular, the vehicle controllers 12 can include an electronic stability controller, a traction controller, etc. It should be understood that, in some embodiments, one or more vehicle controllers 12 can manage more than one type of vehicle operation. For example, in some embodiments, the brakes of the vehicle 10 can be controlled through the brake controller 16 and an electronic stability controller. In other embodiments, these functionalities can be combined in a single vehicle controller 12. Similarly, in some embodiments even “unrelated” vehicle operations can be controlled by one vehicle controller 12.

As illustrated in FIG. 1, in some embodiments, the vehicle controllers 12 are connected via a wired or wireless connection, such as a controller area network (“CAN”) bus 20. In other embodiments, one or more vehicle controllers 12 can be connected via a dedicated connection.

As illustrated in FIG. 1, an application controller 30 is also installed or embedded in the vehicle 10. As described below, the application controller 30 manages software downloaded to the vehicle 10 for modifying the operation of at least one vehicle controller 12. It should be understood that the application controller 30 can be included in a vehicle controller 12 included in the vehicle 10. For example, in some embodiments, the application controller 30 is included in the vehicle's infotainment system. Therefore, the functionality performed by the application controller 30 can be performed by a vehicle controller 12 configured to manage the vehicle's infotainment system (e.g., media management, global positioning system, and other forms of user entertainment and information). It should also be understood that the functionality performed by the application controller 30 can be distributed among multiple vehicle controllers 12.

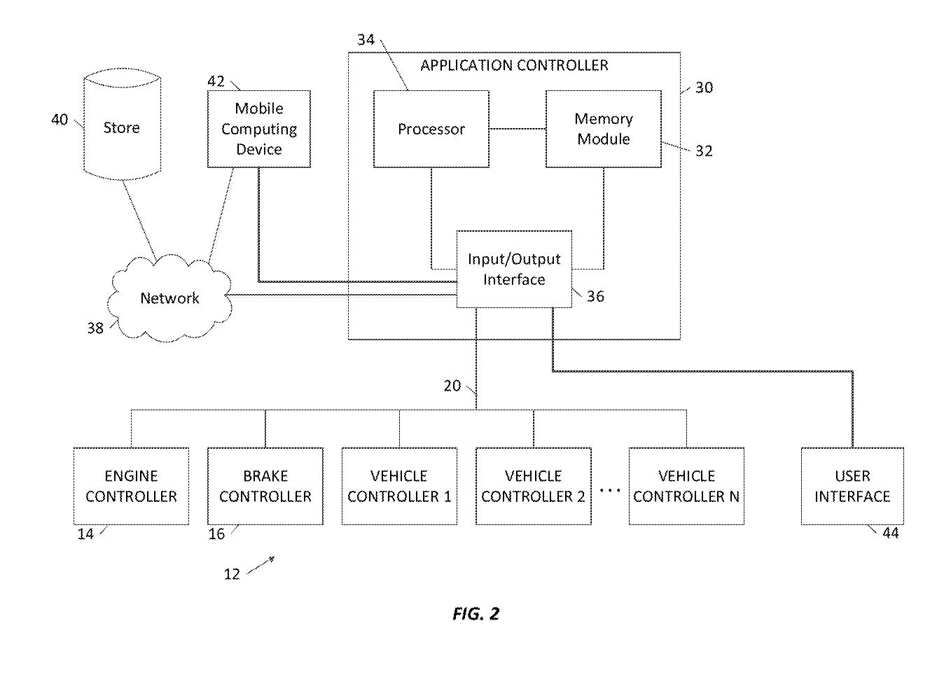

As illustrated in FIG. 2, the application controller 30 includes a memory module 32 (e.g., non-transitory computer-readable medium), a processing unit 34 (e.g., a microprocessor, an application-specific integrated circuit (“ASIC”), etc.), and an input/output interface 36. It should be understood that the application controller 30 can also include additional components and the components of the application controller 30 can be provided in various configurations. Also, as noted above, the application controller 30 can be configured to perform additional functionality than the functionality described below.

The memory module 32 stores instructions executable by the processing unit 34. The memory module 32 also stores data used and generated by the processing unit 34 when executing instructions. Furthermore, the memory module 32 can store downloaded data (e.g., downloaded applications).

The input/output interface 36 allows the application controller 30 to communicate with one or more devices included in the vehicle 10 but external to the application controller 30. For example, in some embodiments, the input/output interface 36 is connected to the CAN bus 20 and, therefore, can communicate with one or more of the vehicle controllers 12 included in the vehicle 10. The input/output interface 36 can also communicate with one or more networks or devices external to the vehicle 10. For example, the input/output interface 36 can connect to a network 38 (e.g., the Internet) external to the vehicle 10, such as through a cellular network (e.g., a 3G or 4G network). Through the network 38, the application controller 30 can connect with and communicate with other devices or systems also connected to the network 38, such as servers including a “store” 40. As described below, the store 40 is a server that provides software applications for download. To communicate with the network 38, the application controller 30 can include a wireless transceiver or other mechanism that allows the application controller 30.

In addition or alternatively, the application controller 30 can be configured to communicate with a mobile computing device 42, such as a user's smart phone, tablet computer, etc., to access networks and devices external to the vehicle 10 (including the network 38 and the store 40). For example, the application controller 30 can communicate with a user's smart phone over a wired or wireless connection e.g., a short-range wireless connection, such as Bluetooth). Accordingly, if the mobile computing device 42 can access other networks and devices (e.g., over the Internet), the application controller 30 can also access these networks and devices indirectly through the mobile computing device 42.

As illustrated in FIG. 1, the application controller 30 also communicates with a user interface 44 (e.g., a HMI, such as a display or touchscreen). The user interface 44 is mounted in an interior of the vehicle 10, such as on the dashboard or a center console. The user interface 44 allows the user to interact with the application controller 30 to select and manage software downloaded to the vehicle 10. As noted above, in some embodiments, the application controller 30 is part of the vehicle's infotainment vehicle controller. Therefore, a user may also use the user interface 44 to manage infotainment functionality or other vehicle controls (e.g., heating and cooling, parking assistance, etc.). As noted above, the user interface 44 can include a touchscreen. Alternatively or in addition, the user interface 44 can be associated with one or more input mechanisms (e.g., buttons, joystick, dials, stylus, etc.) that allow a user to provide input to the application controller 30 (and other vehicle controllers 12). As illustrated in FIG. 2, the application controller 30 can communicate with the user interface 44 over a dedicated connection (e.g., wired or wireless). Alternatively or in addition, the application controller 30 can communicate with the user interface 44 over the CAN bus 20.

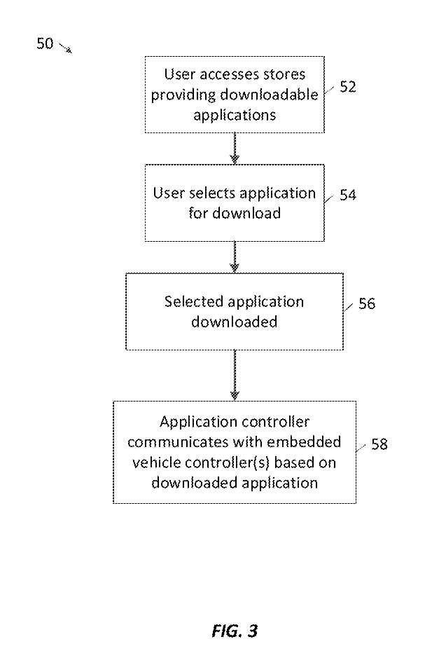

As noted above, embodiments of the invention allow a user to select and download (e.g., for free or for a cost) an application (i.e., a software program) for an embedded vehicle controller 12 that modifies the operation of the vehicle controller 12. For example, FIG. 3 illustrates a method 50 for downloading applications and other data to the vehicle 10, as managed by the application controller 30. As illustrated in FIG. 3, the user initially accesses the store 40 offering downloadable applications (at block 52). The store 40 can be provided as a website where applications can be downloaded. The website can provide a listing of applications available for download. The user can access the website through the application controller 30 and/or the user's mobile computing device 44. For example, the application controller 30 and/or the mobile computing device 44 can execute a general-purpose browser application that accesses websites available over the network 38, including the website provided through the store 40. In other embodiments, the application controller 30 and/or the mobile computing device 44 can execute a specially-programmed application that allows the user to access the store 40 over the network 38 (but not necessary other websites also available over the network 38, as provided by the general-purpose browser application). Accordingly, the listing of applications available for downloaded can be displayed on the user interface 44 included in the vehicle 10 and/or on a user interface provided on the mobile computing device 42.

In some embodiments, the store 40 categorizes available applications according to functionality (e.g., engine control, brake control, etc.) and/or vehicle type. The store 40 can also allow a user to conduct searches and filtering to identify a desired application. Also, in some embodiments, the application controller 30 and/or the mobile computing device 42 is configured to provide (e.g., automatically) data to the store 40 that identifying the vehicle 10 (e.g., the type of vehicle 10, such as make, model, and year and/or the type of vehicle controllers 12 included in the vehicle 10). For example, the identifying data can indicate that the vehicle 10 is a Ford® Focus® or that the vehicle 10 includes a vehicle controller having a particular version or model number. The store 40 can use this received information to automatically modify the listing of applications for download displayed to the user (e.g., to show only those applications that are compatible with the user's vehicle).

From the displayed applications available for download, the user selects an application for download (at block 54). Based on the user selection, the selected application is downloaded (at block 56). In some embodiments, the selected application is downloaded to the application controller 30 (e.g., regardless of whether the application was selected through the application controller 30 or the mobile computing device 44). The application controller 30 is configured with knowledge of the communication protocol of the vehicle 10, such as the communication protocol used on the CAN bus 20. Therefore, the application controller 30 interfaces with the appropriate vehicle controller 12 applicable to the downloaded application (e.g., the engine controller 14, the brake controller 16, etc.) using the known communication protocol to modify vehicle operation handled by the vehicle controller 12 (at block 58).

The downloaded application can be used in a variety of ways to modify vehicle operation. For example, in some embodiments, the application controller 30 communicates with a vehicle controller 12 to push the downloaded application directly to the vehicle controller 12, and the vehicle controller 12 is configured to load and implement the downloaded application (or a version thereof) (e.g., flash or reprogram memory to install new embedded software). In other embodiments, the application controller 30 is configured to use the downloaded application (e.g., execute the downloaded application) to push operating parameters to an embedded vehicle controller 12. For example, the application controller 30 can communicate with a vehicle controller 12 (e.g., using a CAN message) to change variant coding or to activate or deactivate a function switch associated with a vehicle controller 12. In some embodiments, the application controller 30 executes the downloaded application to determine the parameters to transmit (e.g., based on current vehicle parameters or operation) and generate the applicable message(s).

Also, in some embodiments, the application controller 30 uses the downloaded application to prompt a user for parameters or customizations through the user interface 44. For example, if the downloaded application adjusts a following distance for adaptive cruise control, the application controller 30 can be configured to execute the downloaded application, which prompts the user for a desired following distance. The application controller 30 (e.g., through executing the downloaded application) then pushes the user-selected distance to the applicable embedded vehicle controller 12. For example, the application controller 30 (e.g., through executing the downloaded application or separate from the downloaded application) generates a message (e.g., a CAN message) that includes the changes selected by the user. The message is then transmitted to the appropriate vehicle controller(s) 12 to change, for example, variant code definitions in the production software originally installed in the vehicle by the vehicle manufacturer. Therefore, using the information in the message, the embedded vehicle controller 12 changes its performance. It should be understood that in some embodiments, the application controller 30 communicates with multiple embedded vehicle controllers 12 for a single downloaded application (e.g., to change the functionality of more than one vehicle controller 12 and/or push new software to more than one vehicle controller 12).

As previously noted, in some embodiments, rather than downloading the selected application to the application controller 30 to the vehicle 10), the user-selected application is downloaded to a mobile computing device 42, such as the user's smart phone. The mobile computing device 42 communicates with the application controller 30 to provide the data necessary for modifying vehicle operation. For example, in some embodiments, the mobile computing device 42 transmits the downloaded application to the application controller 30. In this situation, the mobile computing device 42 can act as a passive gateway through which applications are downloaded to the vehicle 10. However, in other embodiments, the mobile computing device 42 plays a more active role in modifying vehicle operation. For example, in some embodiments, the mobile computing device 42 executes the downloaded application to identify operating parameters and/or messages for embedded vehicle controllers 12. The mobile computing device 42 can then communicate with the application controller 30 to provide the identified operating parameters and/or messages. The application controller 30 uses the received parameters and/or message to generate the appropriate messages for the embedded vehicle controller(s) 12.

In still other embodiments, the mobile computing device 42 executes the downloaded application to obtain user-selected operating parameters. For example, in some embodiments, the mobile computing device 42 executes the downloaded application to generate screens that prompt the user for operating parameters. The screens can be displayed on the mobile computing device 42 and/or transmitted to the application controller 30 (e.g., for display on the user interface 44). If the screens are displayed on the mobile computing device 42, the mobile computing device 42 receives the user input and forwards the input or messages based on the input to the application controller 30. The application controller 30 receives the input from the mobile computing device 42 and transmits the appropriate messages to the appropriate embedded vehicle controller(s) 12.

Accordingly, as described above, embodiments of the invention allow a user to interact with a store to directly select and obtain new calibrations for a vehicle. This process improves current techniques for modifying or customizing vehicle operation, which generally require particular tools and skills and, therefore, are unavailable to the ordinary user. Accordingly, a user can select what customizations are desired and directly manage the installation and updating associated with the customizations. The user can interact with the store 40 directly from the vehicle 10 (e.g., through the application controller 30) or indirectly through a mobile computing device 42. Either way, the user obtains the selected software that is used to modify vehicle performance (e.g., engine performance, brake performance, electronic stability control performance, traction control performance, etc.). It should be understood that modifying vehicle performance can include changing vehicle performance (e.g., changing fuel injection rates) or activating or deactivating vehicle functionality (e.g., turning on rear camera functionality or turning off acceleration limits).

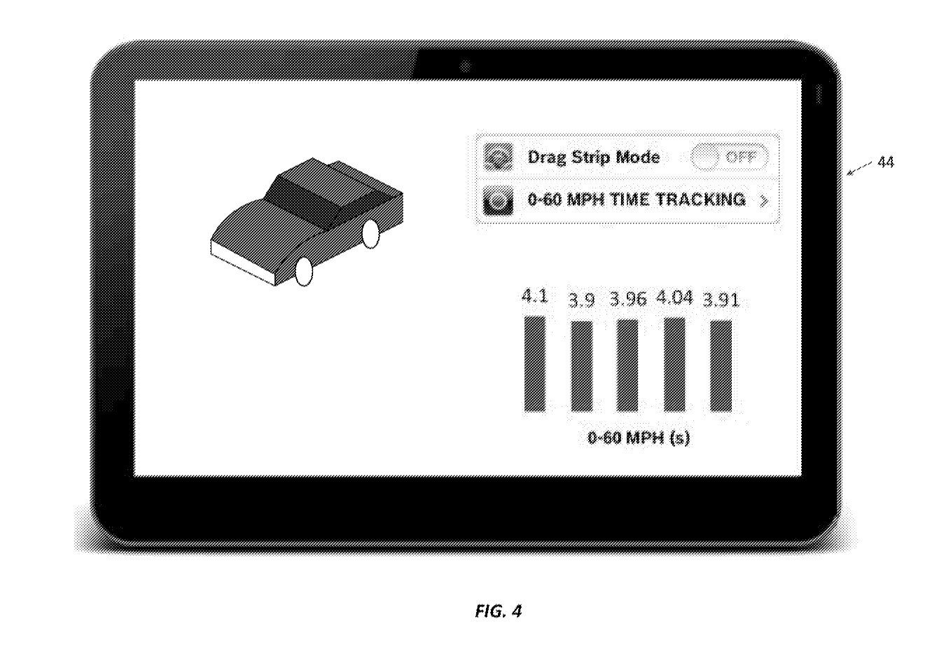

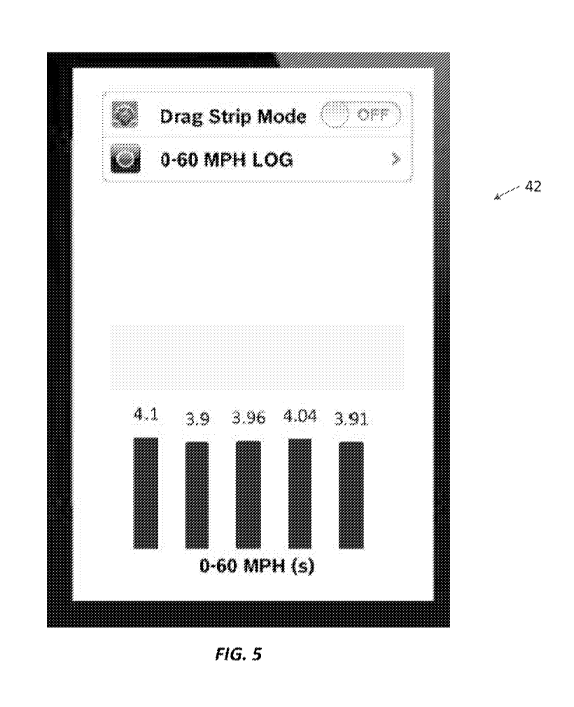

It should also be understood that the downloaded applications can be used to calibrate or customize numerous types of vehicle operation. In particular, downloaded applications can be used to customize traction control, dashboard displays (e.g., to change the electronically-generated display from a display for a Dodge® Dart® to a Fiat® 500), launch control, anti-lock brake systems, electronic stability control, battery management, diagnostic procedures, security systems, etc. For example, FIG. 4 illustrates a screen generated by an example downloaded application that allows a user to customize launch control (e.g., to achieve high performance acceleration from a standstill). As described above, in some embodiments, the downloaded application is executed by the application controller 30. Therefore, as illustrated in FIG. 4, the screen can be displayed on the user interface 44 included in the vehicle 10. As also described above, in some embodiments, the application is downloaded to the user's mobile computing device 42. In these embodiments, the mobile computing device 42 can execute the downloaded application to generate and display a screen on a user interface of the mobile computing device 42 as illustrated in FIG. 5. As described above, when the application is initially downloaded to the user's mobile computing device 42, the application controller 30 can communicate with the mobile computing device 42 (e.g., using Bluetooth) to indirectly receive the downloaded application and/or receive data or commands based on the downloaded application (e.g., user input, CAN messages, etc.).

As illustrated in FIGS. 4 and 5, the example downloaded application allows a user to turn on and off (e.g., using a toggle button) a drag strip mode for launch control. Accordingly, the downloaded application is a control calibration application for use, for example, at the drag strip. Among other features, this application can include a launch control parameter set calibrated with race tire data that is enabled by turning on the drag strip mode. Accordingly, when a user turns on the drag strip mode, the application controller 30 generates a message for the appropriate vehicle controller 12 that provides the launch control parameter set. Similarly, when a user turns off the drag, strip mode, the application controller 30 generates a message for the appropriate vehicle controller 12 that returns the vehicle to a previous or default launch control configuration.

In some embodiments, the downloaded application also displays vehicle information to a user. For example, as illustrated in FIGS. 4 and 5, the downloaded application displays time tracking for the vehicle 10 (e.g., how fast the vehicle 10 has been accelerating from 0 to approximately 60 miles per hour). Therefore, in some embodiments, the downloaded application (and/or the application controller 30) can be configured to obtain vehicle data (e.g., over the CAN bus 20) and present the data or a portion or version thereof to the user. Alternatively of in addition, the downloaded application can use the obtained vehicle data when configuring one or more of the embedded vehicle controllers 12. For example, if a vehicle's fuel efficiency is already set at an “economy” mode, the application controller 30 may not transmit a message to the engine controller 14 even though the user selected the “economy” mode through the downloaded, application.

Thus, embodiments of the invention provide systems and methods for modifying vehicle operation provided by an embedded vehicle system using a user-selected downloaded application. The user-selected application is downloaded to a device, which can include a controller installed in the vehicle or a mobile computing device. In some embodiments, the downloaded application provides one or more screens that allow a user to set customized parameters, function sets, and codes for vehicle operation. The user selections are forwarded to the appropriate embedded vehicle systems (e.g., using an existing CAN bus or other communication protocol). The embedded vehicle systems receive the messages and change operation accordingly (i.e., update embedded software used by the systems). Alternatively or in addition, the downloaded application can be used to flash newly-released user-selected embedded software to embedded systems (e.g., flash or reprogram memory associated with and used by the embedded system). Therefore, a user can easily and quickly customize and modify the operation and performance of their vehicle without requiring special programming tools or skills.

Various features of the invention are set forth in the following claims.

What is claimed is:

1. A system for modifying vehicle operation, the system comprising:
a controller installed in a vehicle, the controller configured to
receive a user-selected operating parameter obtained through a downloaded application,
generate a message for at least one embedded vehicle controller based on the user-selected operating parameter, and
transmit the message to the at least one embedded vehicle controller, wherein the message causes the at least one embedded vehicle controller to modify operation.

2. The system of claim 1, wherein the controller is further configured to receive the downloaded application and execute the downloaded application to generate and display a screen prompting a user to input the user-selected operating parameter, wherein the screen is displayed on a user interface mounted in the interior of the vehicle.

3. The system of claim 1, wherein the controller is configured to receive the user-selected operating parameter from a mobile computing device, wherein the mobile computing device is configured to receive the downloaded application, execute the downloaded application to generate and display a screen prompting a user to input the user-selected operating parameter, and transmit the user-selected operating parameter to the controller.

4. The system of claim 3, wherein the controller is configured to receive the user-selected operating parameter from the mobile computing device using a short-range wireless connection.

5. The system of claim 1, wherein the controller is configured to transmit the message to the at least one embedded vehicle controller over a controller area network.

6. The system of claim 1, wherein the at least one embedded vehicle controller includes at least one selected from a group comprising an engine controller, a brake controller, an electronic stability controller, and a traction controller.

7. The system of claim 1, wherein the controller is further configured to access a server external to the vehicle over a wireless connection, obtain a listing of available applications for download, displaying the listing to a user on a user interface mounted in the vehicle, receive a selection from the listing from the user through the user interface, and download the downloaded application from the server.

8. The system of claim 7, wherein the controller is further configured to provide data identifying the vehicle to the server and the server is configured to modify the listing based on the data identifying the vehicle.

9. The system of claim 1, wherein the message includes instructions for changing variant coding at the at least one embedded vehicle controller.

10. The system of claim 1, wherein the message includes instructions for activating a function switch at the at least one embedded vehicle controller.

11. A method of modifying vehicle operation, the method comprising:
receiving, from a user, a selection of an application available for download;
downloading the selected application to a device;
modifying operation of at least one embedded vehicle controller based on the selected application.

12. The method of claim 11, wherein downloading the selected application to the device includes downloading the selected application to a controller installed in a vehicle.

13. The method of claim 12, wherein modifying operation of the at least one embedded vehicle controller based on the selected application includes executing the selected application by the controller to generate a screen for a user interface included in the interior of the vehicle, the screen prompting the user to input at least one user-selected parameter.

14. The method of claim 13, wherein modifying operation of the at least one embedded vehicle controller based on the selected application includes generating a message for the at least one embedded vehicle controller based on the at least one user-selected parameter and transmitting the message to the at least one embedded vehicle controller.

15. The method of claim 14, wherein generating the message includes generating a controller area network message.

16. The method of claim 11, wherein modifying operation of the at least one embedded vehicle controller based on the selected application includes flashing memory associated with the at least one embedded vehicle controller based on the selected application.

17. The method of claim 12, wherein receiving the selection includes receiving the selection by the controller through a user interface mounted in an interior of the vehicle.

18. The method of claim 12, wherein receiving the selection includes receiving the selection through a user interface on a mobile computing device configured to communicate with the controller.

19. The method of claim 12, wherein downloading the selected application to the device includes downloading the selected application to a mobile computing device configured to communicate with the controller.

20. Non-transitory computer-readable medium comprising executable instructions for:
accessing a listing of applications available for download from a server over a wireless connection;
displaying the listing of applications available for download on a user interface mounted in an interior of a vehicle;
receiving, through the user interface, a selection of an application included in the listing of applications available for download;
downloading the selected application from the server over the wireless connection;
executing the selected application to generate a screen prompting a user for an operating parameter;
displaying the screen on the user interface;
receiving, through the user interface, the operating parameter;
generating a message based on the operating parameter; and
transmitting the message to at least one embedded vehicle controller over a controller area network, the message instructing the at least one embedded vehicle controller to modify software executed by the at least one embedded vehicle controller.
